(19) United States
(12) Patent Application Publication
(10) Pub. No.: US 2014/0136186 A1
(43) Pub. Date: May 15, 2014

(54) METHOD AND SYSTEM FOR GENERATING AN ALTERNATIVE AUDIBLE, VISUAL AND/OR TEXTUAL DATA BASED UPON AN ORIGINAL AUDIBLE, VISUAL AND/OR TEXTUAL DATA

(71) Applicants: TEESSIDE UNIVERSITY, Tees Valley (GB); CONSORZIO NAZIONALE INTERUNIVERSITARIO PER LE TELE, Parma PR (IT)

(72) Inventors: Nicola ADAMI, Brescia (IT); Fabrizio GUERRINI, Brescia (IT); Riccardo LEONARDI, Brescia (IT); Alberto PIACENZA, Brescia (IT); Marc CAVAZZA, Tees Valley (GB); Julie PORTEOUS, Tees Valley (GB); Jonathan TEUTENBERG, Reading (GB)

(73) Assignees: Consorzio Nazionale Interuniversitario per le Telecomunicazioni, Parma PR (IT); TEESSIDE UNIVERSITY, Tees Valley (GB)

(21) Appl. No.: 13/677,797

(22) Filed: Nov. 15, 2012

(51) Int. Cl. G06F 17/27

(52) U.S. Cl. CPC G06F 17/27
USPC 704/9

(57) ABSTRACT

A computer implemented method and system for generating an alternative audible, visual and/or textual data based upon an original audible, visual and/or textual data comprising the step of inputting to a processor original audible, visual and/or textual data having an original plot, extracting a plurality of basic segments from the original audible, visual and/or textual data, defining a vocabulary of intermediate-level semantic concepts based on the plurality of basic segments and/or the original plot, inputting to the processor at least an alternative plot based upon the original plot, modifying the alternative plot in terms of the vocabulary of intermediate-level semantic concepts for generating a modified alternative plot, and modifying the plurality of basic segments of the original audible, visual and/or textual data in terms of said vocabulary of intermediate-level semantic concepts for generating a modified plurality of basic segments.

### FIELD OF THE INVENTION

The present invention generally relates to a method and a system for generating an alternative audible, visual and/or textual data constrained with an original audible, visual and/or textual data. Particularly, but not exclusively, the present invention relates to a method and a system for generating story variants of a film with constrained video recombination by letting the user play an active role instead of just watching the original story of the film as it unfolds.

### BACKGROUND OF THE INVENTION

Video analysis techniques are used in the art to automatically segment the video into Logical Story Units (LSU). It is possible to match LSUs to high level concepts corresponding to narrative actions. In particular, results obtained using such known techniques indicate that there is about 90% correspondence between LSUs and narrative concepts.

Such known techniques are described, for example, in the U.S. Pat. No. 5,604,855. In such a patent the storyline of a dynamically generated entertainment program, such as a video game, is generated using a matrix of reusable storyline fragments called substories. In detail, a set of characters that participate in the storyline is established and a set of reusable substories is defined. Each substory represents a “fragment of a story”, usually involving an action by a subject, where the subject is one of the characters. Most substories can be reused multiple times with a different one of the characters being the subject and a different one of the characters being the direct object of the substory. Each substory has a set of possible reaction substories, which are a subset of the defined substories. A plan list stores plan data indicating each of the substories to be performed at specified times. An initial “seed story” in the form of an initial set of substories is stored in the plan list. The substories stored in the plan list are executed at times corresponding to their respective specified times. For at least a subset of the executed substories, the end user of the system is either shown a video image representing the executed substory or is otherwise informed of the executed substory. In reaction to each executed substory, plans to perform additional substories are generated. The additional substories are taken from the set of possible reaction substories for each executed substory. Each plan to perform an additional substory is assigned a specified time and plan data representing the plan is stored in the plan list.

To generate narratives using planner constraint based approach and to use LSU at runtime as building blocks, which are sequenced in different ways to collate content for output video, however shows limits and problems such as:
utilization of only pre-existing actions;
possibility of presenting only subparts of the original baseline movie in terms of narrative;
rigid planning based on Character Point of View (PoV), which in turn does not allow to tell the story from different viewers' perspective and does not include specification of asymmetric actions.

### SUMMARY OF THE INVENTION

In view of the above, it is an aim of the present invention to provide a method and a system for generating an alternative audible, visual and/or textual data constrained with an original audible, visual and/or textual data able to overcome the aforementioned drawbacks and limits.

The scope of the present invention deals with a computer implemented method and a respective system able to recombine the content of the input audible, visual and/or textual data by mixing basic segments of the original audible, visual and/or textual data to convey an internally consistent, alternative story, according to the features claimed in claims 1 and 21, respectively.

Thanks to the innovative computer implemented method and system two functional advantages are achieved.

First, the narrative generation can be constrained by what is ultimately playable, as the video processing unit semantically describes the video content and then communicates the available resources for the alternative plot to the planner.

Second, while the video processing module recombines the video segments to answer to a specific narrative action request by the planner (properly translated into the semantic concepts of the vocabulary), it also computes the final visual coherence of the recombined content through heuristics. If it deems the coherence insufficient, the video processing unit reports a fail, allowing the planner to search for an alternative solution producing a better match for the requested criteria.

### BRIEF DESCRIPTION OF DRAWINGS

The various features of the present invention will be progressively described in greater detail with reference to the following description, claims, and drawings, wherein reference numerals are reused, where appropriate, to indicate the correspondence between the referenced items, and wherein:

FIG. 1 is a schematic flow chart of the main input/output modules forming the method and the system according to the present invention;

FIG. 2 is a more detailed flow chart of the method and the system according to the present invention;

FIG. 3 is a more detailed flow chart of the communication protocol between the modules forming the method and the system according to the present invention;

FIG. 4A shows a graphical representation of the decomposition of a baseline input movie into Logical Story Units (LSUs);

FIG. 4B shows a graph depicting in more detail the baseline input movie segmentation in LSUs using the transitions between clusters of visually similar shots;

FIG. 4C shows a graphical representation of the process of obtaining a semantics of the shots concerning the characters present and their mood, the environment and the field of the camera;

FIG. 4D shows a graphs describing how the LSU are re-clustered obtaining the Semantic Story Units (SSUs);

FIG. 4E shows an interface for the user input;

FIG. 4F shows graphs describing a specific step of the video recombination process, i.e. the semantic cluster substitution within a Semantic Story Unit;

FIG. 4G shows graphs describing a specific step of the video recombination process, i.e. the fusion of the Semantic Story Units;

FIG. 4H shows the process of mapping narrative actions to actual video shots using their semantic description;

FIG. 5A to 5D show graphs associated to a running example.

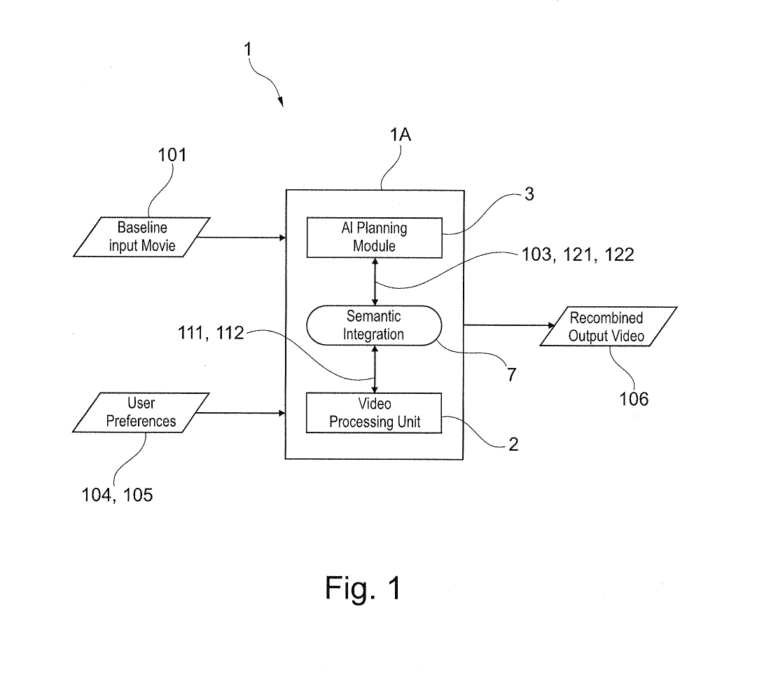

### DETAILED DESCRIPTION

In the following description the present invention is described with the reference to the case in which the original audible, visual and/or textual data is a sequence of images of moving objects, characters and/or places photographed by a camera and providing the optical illusion of continuous movement when projected onto a screen, i.e. a so called film, but without limits the original audible, visual and/or textual data can be any other original piece of data, either a work of art or not, whose content could be meaningfully recombined to convey an alternate meaning. Examples include purely textual media such as books and novels, audio recordings such as diplomatic or government discussions, personal home made videos and so on.

The following definitions provide background information pertaining to the technical field of the present invention, and are intended to facilitate the understanding of the present invention without limiting its scope:

Baseline Data:

The original work of art that represents the main input of the invention. In principle, the baseline data could be expressed in many diverse mediums as long as its objective is to convey a story to the end user. For the sake of this embodiment of the invention, the baseline data is a digital movie or film, including both its digital representation of the visual and audio data and every piece of information accompanying it such as its credits (title, actors, etc.) and the original script.

Intermediate Level (Mid-Level) Attributes (or Concepts):

A way to represent the content using attributes that are more sophisticated than low-level features which are normally adopted to describe the characteristics of the raw data, but that nonetheless do not express high-level concepts that generally would convey the precise semantics of information using elements of natural language. In the present invention, intermediate level attributes represent a layer that is facilitating a mapping between low-level features and high-level concepts. In particular high-level concepts, that take the form of semantic narrative actions, are modelled as aggregates of intermediate level attributes (see the definition of semantic sets and patterns in what follows).

Data Segments:

The basic subparts of the baseline data which are used as elementary recombination units by the system. In the case of video, they could be obtained through a video segmentation process of whatever kind. In the preferred embodiment, the video segments are actually video shots as identified by running a shot cut detector software, thus the video segments have variable duration. Since the shots length are under the movie director's control, the duration of any given shot could range from a fraction of a second to many minutes in extreme cases.

Storytelling:

is the conveying of events in words, images and sounds, often by improvisation or embellishment. Stories or narratives have been shared in every culture as a means of entertainment, education, cultural preservation and in order to instil moral values. Elements of stories and storytelling include plot, characters and narrative point of view to name a few.

With reference to the attached Figures, it is denoted with 1 a system and a method for generating an alternative audible, visual and/or textual data 106 constrained with an original audible, visual and/or textual data 101.

Preferably the method is implemented automatically by means of a computer, such a personal computer or an electronic device in general suitable for performing all the operations requested by the innovative method.

Particularly, as described in detail in the hereinafter description, the innovative method and system allow the user play an active role instead of just watching the story as it unfolds. In fact, with the aid of a simple graphical interface (not disclosed in the Figures), the user chooses an alternative plot for the baseline film (or movie) among those provided by an author, the choices including a different ending and the various characters roles as well.

To this end, the system 1 comprises a video based storytelling system (in short VBS) 1A having a video processing unit 2 and—a Plot Generator 3. The VBS 1A receives as input the baseline input movie 101 and the user preferences 104, 105. The outcome of the method and of the system is recombined output video 106 which can have a different ending with the various characters holding different roles as well with respect to the baseline input movie 101.

Advantageously, the VBS 1A of the system 1 comprises also a semantic integration layer 7 interposed between the video processing unit 2 and the Plot Generator 3.

It is to be noted that:
the video processing unit 2 deals with the low-level content analysis of the input the baseline input movie 101, i.e. the video processing unit 2 extracts a plurality of basic segments 111,113 from the original film 101;
the Plot Generator 3 takes care of the narrative generation, i.e. it takes care of the generation of alternative narrative actions 103,121,122 with respect to the plot of the baseline input movie 101.

The integration of the semantic integration layer 7 exploits a common vocabulary of intermediate-level semantic concepts that is defined pre-emptively, i.e. the vocabulary of intermediate-level semantic concepts is stored in a storing means of the computer.

The common vocabulary of intermediate-level semantic is defined a priori and could be either manually determined by the system designer or automatically obtained by the system through a pre-emptive content analysis.

Hence, both the basic video segments 111,112 as obtained by the video processing unit 2 and the alternative narrative actions 103,121,122 constituting the plot generated by the Plot Generator 3 are expressed in terms of the common semantic vocabulary.

Thanks to this feature it is possible to establish a communication medium or interface between the video processing unit 2 and the Plot Generator 3.

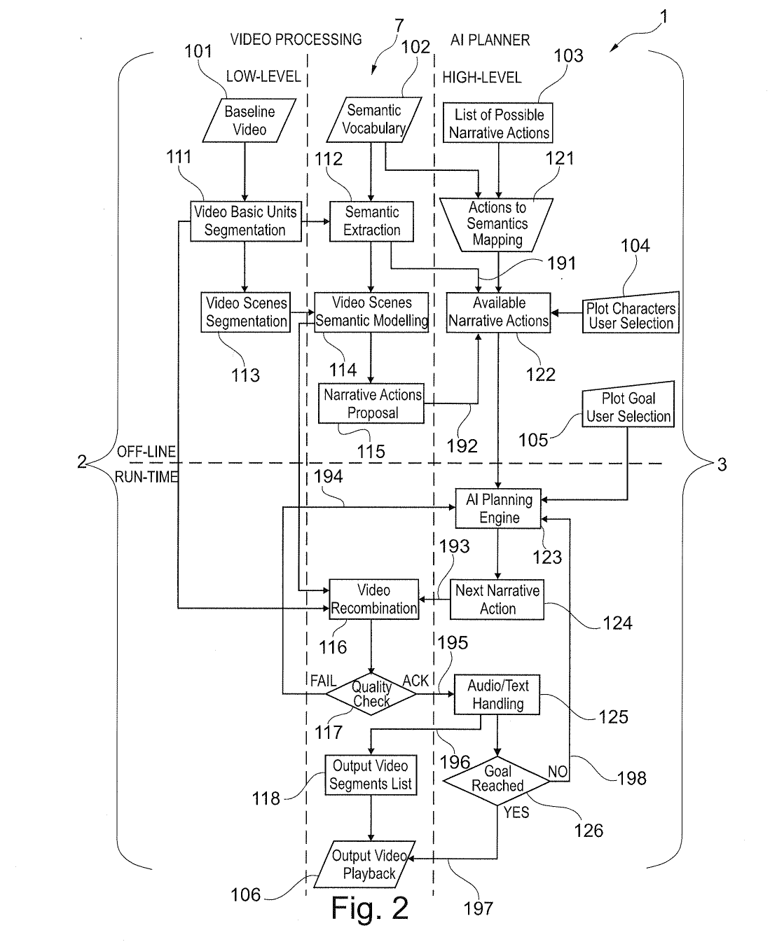

With reference to FIG. 2, in which it is sketched the functional overview of the system and method according to the present invention, it is possible to note that the top section of such FIG. 2 illustrates the pre-processing performed, preferably, off-line while the bottom section schematizes the run-time functioning.

The video processing unit 2 deals with the analysis of the video 4, down to the actual low-level video content (left column), while the Plot Generator 3 works in terms of the high-level concepts tied to storytelling (right column).

The joint use of the video processing unit 2 and of the Plot Generator 3, which is made possible through the development of semantic integration layer 7 (central column), permits to overcome the limitations of existing video-based storytelling systems as disclosed in the art, which are based on branching structures or recombination of manually defined video segments.

The invention adds a new dimension to the entertainment value of the baseline input film 4 because it allows the user to tune the movie experience to his/her preferences. Instead of simply watching the movie as it unfolds its story as the director envisioned it, the user chooses an alternative plot, through the user preferences 104,105, with respect to the original one using a simple graphical interface. This choice consists in selecting a different narrative, right down to the ending, among those made available by an author and also possibly in recasting the original characters in different roles.

Therefore, the objective of present invention is to recombine the content of the baseline video (input 101) to obtain a new film that is eventually played back for the user (output 106).

The recombined video mixes together basic segments 111,113 of the original baseline input movie 101, that can come from completely different original movie scenes as well, to convey the alternative plot consistently with the user preferences 104,105, as expressed through the graphical interface.

It is to be noted that the audio portion of the baseline input movie 101 should be discarded because the recombination breaks up the temporal flow. Furthermore, to convey an alternative plot it is very likely that the characters should speak different lines than those of the original script; therefore, the original soundtrack usually cannot be used and other solutions have to be implemented. For example, synthesized speech may be incorporated in the scene or alternative subtitles could be juxtaposed to describe what the meaning of the scene is. To further enhance the quality of the recombined video, the time flow of the recombined video may also benefit from the introduction of ad-hoc visual cues about the change of context (such as a subtitle confirming that the story has moved to a new location) which may lose its immediacy due to the content mixing.

The functionalities of the video processing unit 2 are tightly integrated with those of the Plot Generator 3 through the development of the common vocabulary (input 102) thanks to which the video processing unit 2 and the Plot Generator 3 exchange data.

The vocabulary is constituted of intermediate-level semantic values that describe raw information on what is actually depicted in the baseline video 101, such as the characters present in the frame and the camera field. Thanks to this interaction, the high-level Plot Generator 3 gathers information from the video processing unit 2 about the available video material and the visual coherence of the output narrative and therefore can add suitable constraints to its own narrative construction process.

The relevant semantic information extraction from the baseline video 101 is performed, preferably, offline by the video processing unit 2.

To this end, first, a video segmentation analysis (process 111) separates the baseline video 101 into basic units of video content. The actual semantic information is then extracted independently from each video segment (process 112), either automatically, or manually or both, depending on the semantic set forming the vocabulary.

Which semantic information is needed actually reflects how the narrative actions composing the alternative plot are defined, as described below. The characters present in each video segment is a mandatory semantic information to construct a meaningful story; in the video processing unit 2, a generic semantic value is attached to each character such as “character A” as they are extracted.

The recombined video constituting the alternative movie is in the end a sequence of these basic video segments (data block 118), but from the Plot Generator's high-level point of view it is modelled by a sequence of narrative actions. The Plot Generator 3 has to choose the appropriate narrative actions from a pool of available ones (data block 122). The possible narrative actions can be selected both independently from the baseline video content 101 or as slight variations of the available content and are pre-emptively listed in the Plot Generator domain (manual input 103). Such possible actions are manually input by the system designer to form a narrative domain.

The identity of the characters possibly performing them plus other important action descriptors are initially specified as parameters: for example, a narrative action could be “character Ac1 welcomes characters Bc2 in location Ll1 at time Tt1”.

In the Plot Generator's domain, the narrative actions are also expressed in terms of the semantic vocabulary through a mapping between the considered actions and specific attributes values that reasonably convey the intended meaning. For example, the welcoming narrative action above could be expressed by four video segments, two of character Ac1 and two of character Bc2. For credibly represent a certain action, all the other data segments attributes which are part of the adopted common vocabulary should also match in some specified way (e.g. all of the video segments have to be either indoor or outdoor). A human author has to meaningfully construct these mappings (manual process 121), but this work needs to be done only once and it carries on with every input baseline video 4.

The semantic description 7, i.e. the static action filtering, of the raw basic video segments 111 is communicated to the Plot Generator 3 before the run-time narrative construction (arrow 191) as an ordered list; this is combined with the roles of the characters involved in the plot supplied by the user (manual input 104).

The Plot Generator 3 is supplied with the matching between the extracted semantic values 112 of the characters present in each video segment 111 used by the video processing unit 2 (e.g. the “character A” value) and the character's name of the original baseline video 101 (e.g., Portia) because the original script is assumed as available. This matching is possibly changed because of the user's choices as said above (manual input 104) and thus could be not identical to that of the original script (e.g., the Plot Generator could assign Portia to the semantic value “character B” instead).

Since the characters in each narrative action 115 as described in the plot outputted by the Plot Generator 3 are specified using their actual name (e.g., Portia), just before the Plot Generator 3 requests a narrative action to the video processing unit 2, the latter resolves the parameters in it (e.g. the “c1” value) with the suitable intermediate semantic value (e.g., “character B”). Thanks to the communication of the semantic description 7 of all video segments 113, the Plot Generator 3 performs a so-called static action filtering, that is to say it eliminates (block 122) from its domain those narrative actions that do not have an actual video content counterpart, namely by eliminating all the narrative actions that include a matching between actual characters and semantic values for which the latter are not available. A simple example would be “character A” never being sad in the baseline movie, therefore that character could not be portrayed as such in the alternative story. This way, not all possible narrative actions are actually listed in the set of available ones (data block 122).

Such unavailable actions elimination is necessary when dealing with a fixed baseline video because on-the-fly content generation is not an option, in contrast for example with Interactive Storytelling systems relying on graphics. The Plot Generator 3 alone could have not determined in advance which actions to discard: this fact once again highlights the importance of the semantic integration made possible thanks to the common vocabulary setting and communication exchange.

The video processing unit 2 task at run-time is thus to match narrative actions with the appropriate video content (process 116, more details on this block in what follows).

To do this job effectively, some additional semantic modelling of the baseline video 101 is necessary to enhance the quality of the output video 106.

In fact, the extraction of the video segments 113 pertaining to each narrative action is not just a mere selection process based on the semantic description of all the available segments; instead, the video processing unit 2 makes use of specific models to exploit as much as possible the pre-existing scenes structure of the baseline movie, which is by assumption well-formed. To do that, on top of the basic units segmentation process 111, a video segmentation into logical scenes is also performed (process 113): at its core, a logical scene from a low-level perspective is obtained as a closed cycle of basic video segments sharing common features such as colour, indicating a common scene context.

The scenes representation is then joined with the intermediate-level semantic description 7 obtained offline by the video processing unit 2 to obtain a separate semantic stochastic model for every logical scene (process 114).

In particular, the constituting video segments of each logical scene are clustered according to their semantic description extracted previously. Then, the clusters are associated to nodes of a stochastic Markov chain, in which the transition probabilities are computed using maximum likelihood estimation based on the actual temporal transitions between the original video segments.

The video segmentation 111 into logical scenes 114 and their semantic modelling are also used to directly enrich the available narrative actions list through the narrative actions proposal (process 115).

In fact, it is likely that the logical scenes correspond to original scenes of the baseline video and could thus be used as templates for narrative actions by themselves. Moreover, selected pairs of Markov chain semantic models, associated to separate logical scenes, are fused by exploiting clusters that bear common semantic description: this operation is performed only for those pairs of models that are the most promising in terms of expected outcome, evaluated through a heuristic quite similar to that employed in the visual coherence check of the run-time video recombination engine (decision 117, more details in what follows).

The overall narrative actions proposal process can be thus a combination of computation and manual assessment. The video processing unit 2 assembles a video sample of any candidate narrative action (using the same technique as in process 116, see below), which is then evaluated by an author. If deemed adequate, the new action is added into the available narrative actions list along with its associated mapping to the intermediate-level semantics (arrow 192).

Before each run, the user also supplies the selection of a plot goal (manual input 105) in addition to the already discussed roles of the characters involved (manual input 104). The Plot Generator engine (process 123) at run-time constructs a globally consistent narrative by searching a path going from the initial state to the plot goal state and therefore the resulting narrative path is a sequence of a suitable number of narrative actions chosen among those available.

The plot goal forces the Plot Generator to interpret such plot goal as a number of constraints driving the generation process: the narrative has to move towards the intended leaf node and certain actions must follow a causal path, for example, for character A to perform a particular action in a certain location L he first has to travel to L.

The Plot Generator outputs narrative actions one at a time instead of constructing the whole plot at once, thus interleaving planning and execution. When a new narrative action is specified (data block 124), the Plot Generator 3 translates it into the intermediate-level semantic notation using its internal mapping (as in the previous welcoming action example). It then issues a request to the video processing only for this translated narrative action (arrow 193); crucially, the video processing unit can report a failure to the Plot Generator if certain conditions (specified in what follows) are met (arrow 194). In that case, the Plot Generator eliminates the offending narrative action from its domain and searches a new path to the plot goal.

Otherwise, if the video processing unit 2 acknowledges the narrative action request (arrow 195), the narrative action is successfully added to the alternative plot. The Plot Generator 3 is then asked to supply the video content with the audio and/or text for its playback (process 125) and then pass it back to the video processing unit (arrow 196). The latter final task for the present narrative action is to accordingly update the output video segments list (data block 118). Meanwhile, the Plot Generator 3 moves on by checking if the plot has reached its goal (decision 126). If that is not the case (arrow 198), the Plot Generator 3 computes and requests the successive narrative action. If the goal is reached the video processing unit is signalled (arrow 197) to play back the output video segments list (output 106).

The video processing unit 2 handles the narrative action request on the fly (process 116); its task is to choose an appropriate sequence of video segments whose intermediate-level semantic description matches those listed in the requested translated narrative action. To do that, it first checks if any of the scenes semantic models is a perfect match for the request, that is, if the clusters of a particular scene semantic model have a one-to-one correspondence with each of the requested semantic descriptions. If no such perfect match could be found, the video processing unit constructs one by modifying a number of semantic models that are the most similar to the request to obtain a mixed semantic model; it does so by substituting appropriate clusters from other semantic models and deleting possible extra unnecessary clusters. The best mixed semantic model is then selected by employing a combination of distances computation based on low-level features and high-level heuristics such as the number of clusters that has been needed to substitute and/or delete. Last, the video segments sequence is extracted by performing a random walk on the Markov chain associated to the resulting (eventually mixed) semantic model.

Obviously, due to its nature the recombination process can heavily tamper with the original scenes structure if drastic changes have to be introduced to satisfy the request. This could cause a low visual output quality of the video, hence the video processing unit 2 runs a visual coherence check (decision 117) that computes heuristics to determine the transition similarities with respect to those of the original model structure. If this coherence test is not passed, it triggers a fail response from the video processing unit to the Plot Generator (arrow 194) and forces the latter to change its narrative path, as stated previously.

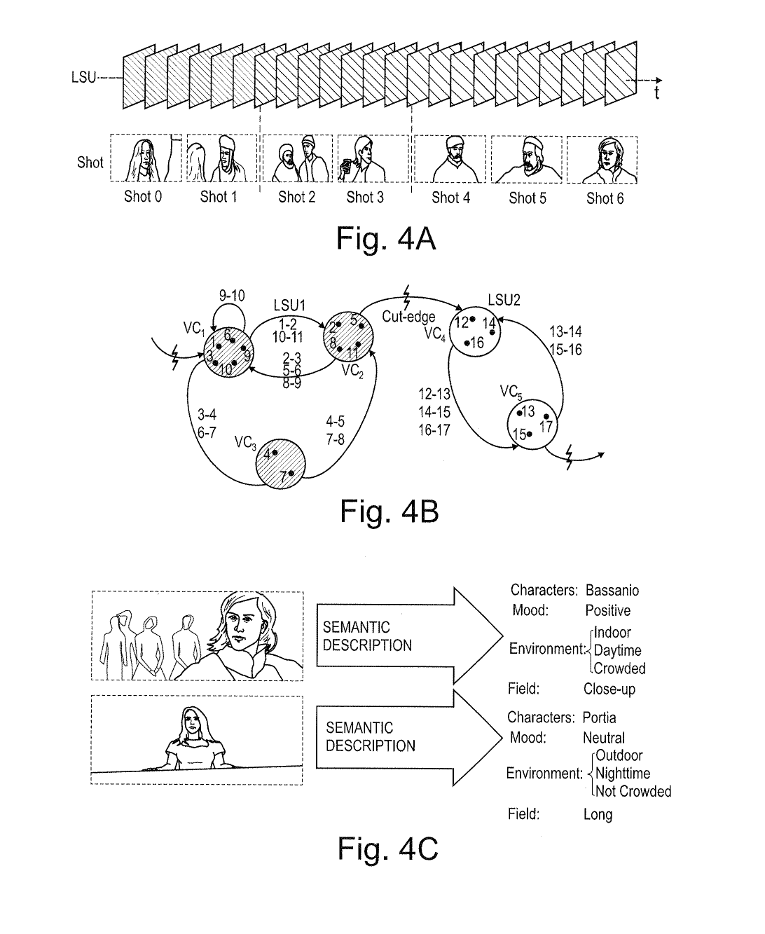

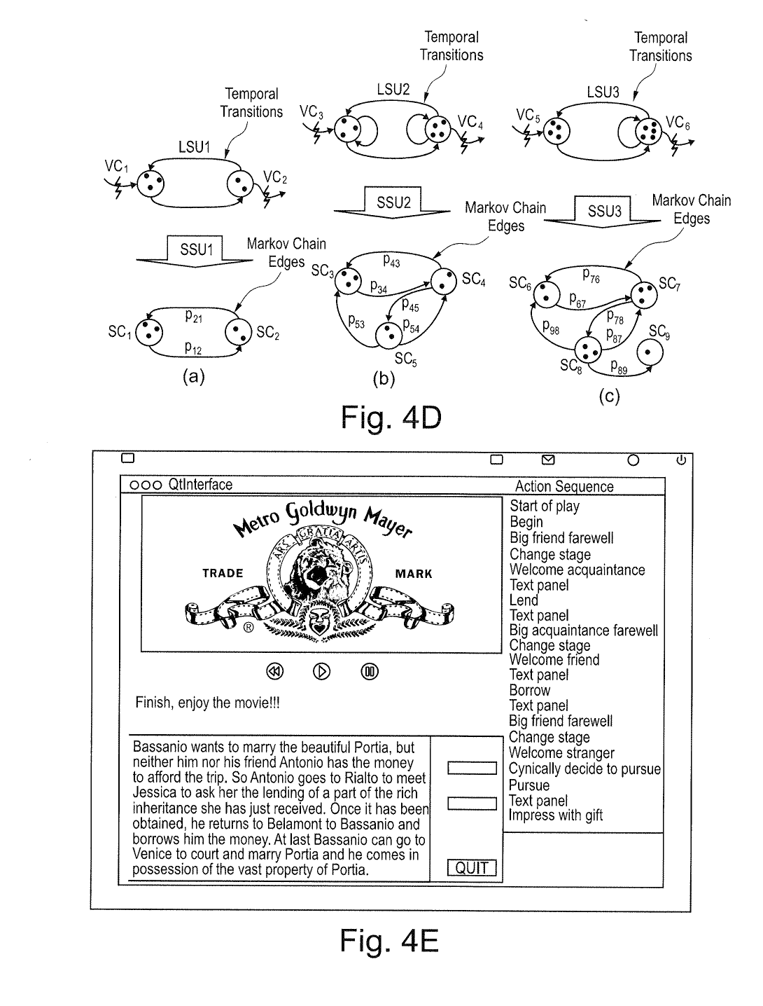

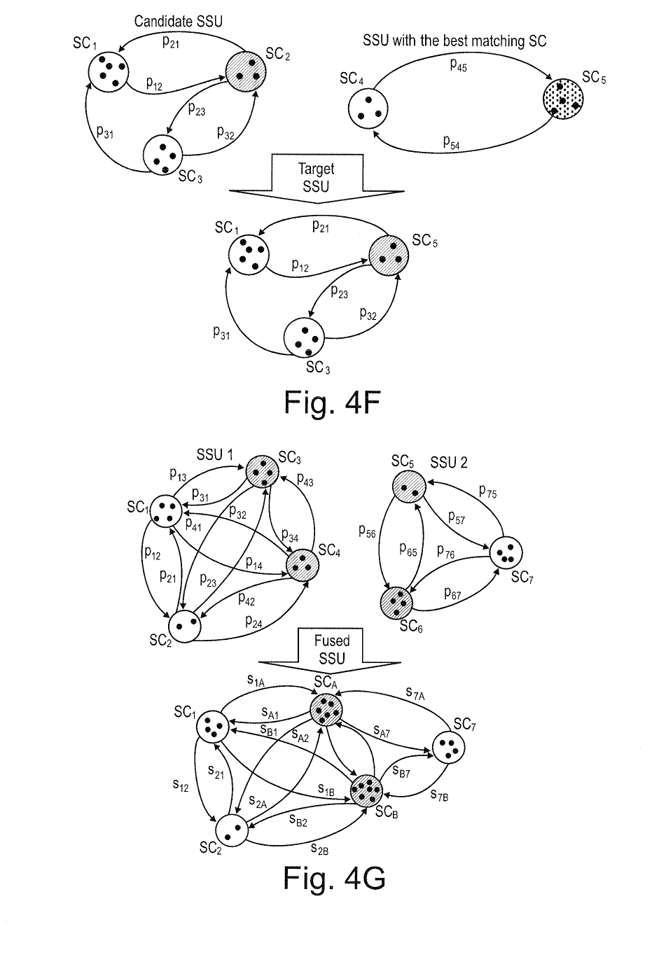

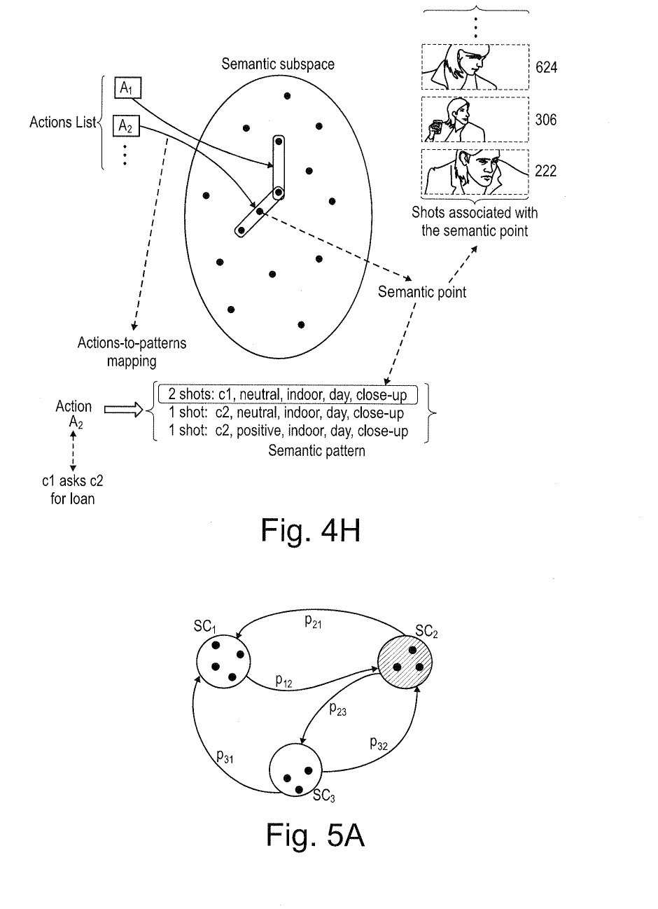

With reference to FIG. 4C, it is to be noted that the basic unit of semantic information is referred to as semantic point, which is a particular instantiation of the common semantic vocabulary that embodies the description of one or more video segments.

For example, a semantic point comprises a set of data such as character A, neutral mood, daytime, indoor; of course, this combination of semantic values may be attached to many different video segments throughout the movie. On top of that, semantic points are used to construct semantic sets, which are sets of video segments described by a given semantic points structure.

For example, a semantic set may be composed of two video segments drawn from the semantic point P={character A, positive mood, daytime, outdoor} and two video segments drawn from the semantic point Q={character B, positive mood, daytime, outdoor}.

Semantic sets constitute the semantic representation of narrative actions, with the characters involved left as parameters: the set above may represent, e.g., the “B welcomes A in location L at time T” action.

The representation of each narrative action through an appropriate semantic set must be decided beforehand and it is actually done during the already discussed mapping from actions to semantics (manual process 121).

The association between the characters parameters of a semantic set and the actual characters involved in the narrative action is done online (process 123 to data block 124) by the Plot Generator 3 engine and makes use of both the information contained in the original script and the user's choices (user input 104).

The association between semantic sets and points in the best embodiment is loose in the sense that there is no pre-determined order for the semantic points while the video processing unit chooses the video segments for the correspondent narrative action.

As an alternative way, it could also be conceived to model the narrative actions as a rigid sequence of semantic points, in which case the semantic set should be properly referred to as a semantic pattern.

The matter of choosing to model the narrative actions as semantic sets or patterns really rests with the choice of where to put the complexity: using sets, it is responsibility of the video processing unit internal models to put the semantic points in the right order so to accurately exploit the pre-existing movie structure; using patterns, the Plot Generator has at its disposal precise models of the narrative actions representation and the task of the video processing unit is thus to select the suitable parts of the movie with which to represent the sequence of semantic points without changing their order.

The semantic points and sets represent the functional means of communication between the Plot Generator and the video processing unit. It is therefore necessary to establish a communication protocol between the two modules. From a logical point of view, two types of data exchange take place: the information being exchanged is mostly based on the common semantic vocabulary (points and sets), but additional data, e.g. fail reports, need also to be passed. The protocol comprises three logically distinct communication phases and a final ending signalling.

The first two phases are unidirectional from the video processing unit to the Plot Generator and they are performed during the analysis phase, before the planning engine is started. The third phase is in fact a bidirectional communication loop, which handles each single narrative action starting from its request by the Plot Generator.

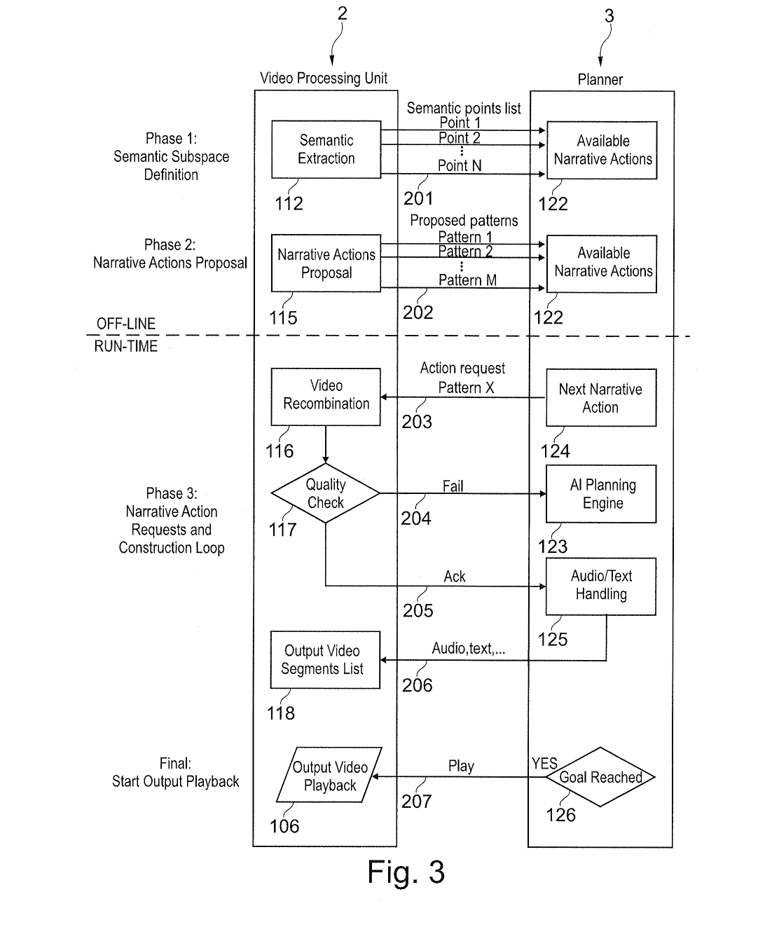

FIG. 3 illustrates from a logical point of view the various communication phases: it is mainly a reorganization of the blocks of FIG. 2 involved in the communication phases. For this reason the indexing of those blocks are retained from those of FIG. 2. Note also that the arrows that represent the communication between the video processing unit 2 and a Plot Generator 3 are also present in FIG. 2 as the arrows that cross the rightmost vertical line (which is in fact the interface between the video processing unit and the Plot Generator), except the top one (which is a common input).

In the first phase of the protocol, right after it has finished the semantic extraction process (process 112), the video processing unit 2 passes to the Plot Generator 3 the entire semantic information pertaining to the baseline video 101, that is all semantic points found in the movie, along with the number of corresponding video segments for each (arrow 201=191). At the end of this communication phase, with the information on the available semantic points the Plot Generator 3 is able to perform the static narrative action filtering to avoid including in the alternative plot actions that are not representable and the available narrative actions list is updated accordingly (data block 122). In other words, the Plot Generator 3 is now able to know which combinations of semantic sets and actual characters to discard from its narrative domain.

In the second phase, the narrative actions proposal process takes place. Therefore, the video processing unit 2 communicates to the Plot Generator a group of semantic sets that might be considered as new narrative actions as assessed by a human author. Obviously, it is also necessary that sample video clips, constructed by drawing video segments according to the specific semantic set, are made available to the author for him to evaluate the quality of the content. As such, they are not part of the communication protocol, but instead they are a secondary output of the video processing unit.

Therefore, the two offline communication phases of the protocol serve complementary purposes for the narrative domain construction. The first phase shrinks the narrative domain by eliminating from the possible narrative actions those that are not representable by the available video content; on the other hand, the second phase enlarges the narrative domain because more narrative actions are potentially added to the roster of available narrative actions.

The online plot construction is a loop, where the Plot Generator 3 computes a single narrative action at a time and it then proceeds to the next action in the plot only after the video processing unit 2 has evaluated the coherence of the recombined video content corresponding to the present action.

Therefore, the third phase of the communication protocol is repeated for each action until the plot goal is reached. After the Plot Generator engine computes a narrative action (data block 124), the latter is also translated into the correspondent set whose parameters, i.e. characters, are suitably set. The set is passed as a request to the video processing unit 2 (arrow 203=193) and the video recombination process takes place (process 116).

After the video segments 111 are assembled, the video processing unit evaluates the its coherence (decision 117) and accordingly gives a response to the Plot Generator 3. If the coherence is insufficient, a fail message is reported to the Plot Generator 3 (arrow 204=194), that hence rewinds its engine (process 123), the communication phase ends and the loop is restarted. Otherwise, the video processing unit 2 acknowledges the narrative action (arrow 205=195) that can be added to the overall story. The Plot Generator 3 has the final task of attaching the audio and/or textual information to the present narrative action (process 125). It then passes this information to the video processing unit (arrow 206=196) so that it can add the video segments along with the audio information to the output list (data block 118).

Finally, when the Plot Generator 3 reaches the plot goal (decision 126), it simply signals (arrow 207=197) the video processing unit 2 to start the video output playback (output 106).

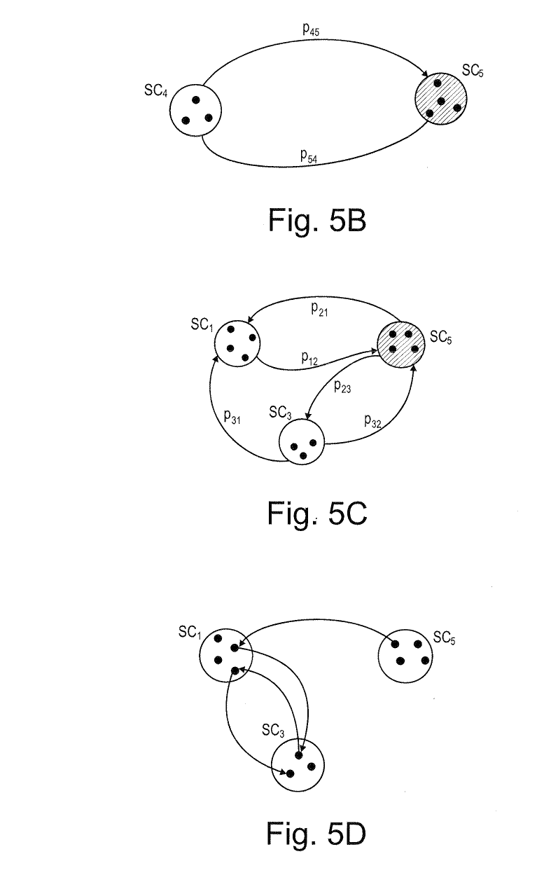

In the following, it will be described a way of carrying out the method with reference to FIGS. 4A-4I and FIGS. 5A-5D. As shown in such Figures, the example will be described with reference to a specific movie, i.e. “The Merchant of Venice” directed by Michael Radford.

With reference to FIG. 4A, the video processing unit 2 decomposes the baseline input movie 101 in Logical Story Units (LSU).

With reference to FIG. 4B, the LSU construction process is detailed. A Scene Transition Graph (STG) is obtained identifying the node of the graph with clusters of visually similar and temporally close shots. The STG is decomposed trough removal of cut-edges obtaining the LSU.

With reference to FIG. 4C, the semantic integration 7 represents the interface between AI planning module 3 and the video processing unit 2 and it is embodied by the semantics of shots being part of the baseline input movie 101, in this case the characters present and their mood, the general environment of the scene and the field of the camera.

With reference to FIG. 4D, as a function of the intermediate representation developed by the semantic integration 7, the LSU are re-clusterized obtaining the Semantic Story Units (SSU). Various scenarios are possible:

(a) The visual clusters and the semantic clusters are perfectly matched;

(b) One of the visual cluster has spawned two different semantic clusters;

(c) An additional cut-edge has been created.

The user input, i.e. the user preferences 104, 105, chooses the characters involved and goals so as to force the Plot Generation module 3 to formulate a new narrative.

In particular, by means of an interface (see FIG. 4E) the user can input the preferences 104, 105.

For example the interface, during the narrative construction stage, allows choosing between at least two different stories, provides a description of the chosen plot and permits to select the characters involved in the narration. Moreover the interface, during the playback, allows the navigation between the main actions of the story and displays the play/pause buttons for the video playback.

In order to obtain the video recombination 116, the video recombination process foresees for each action in the narrative that the system 1 (i.e. the Video—Based Storytelling System VBS) generates a semantically consistent sequence of shots, with an appropriate subtitle; for easier understanding, it interposes a Text Panel when necessary, e.g. when the scene context changes.

With reference to FIG. 4F, the video recombination 116, when the Plot Generator requests an action to the video processing unit 2 through the semantic integration interface 7, the system 1, whether the SSU satisfies the request, outputs the video playback 106 (branch YES of the test 126), otherwise (in the case for example a character is missing or is in excess) goes for a substitution/deletion of the appropriate cluster (branch NO of the test 126). If no solution can be found, a failure is returned to allow for an alternative action generation.

In particular the cluster substitution performed by the video processing unit 2 chooses the SSU that best satisfies the request and it identifies clusters that don't fit in order to substitute them with clusters in other SSUs containing the requested content that best adapt with the SSU visual aspect.

Also, with reference to FIG. 4G, the SSU fusion is foreseen to increase the number of SSUs available to the Plot Generator 3. Starting from two different SSUs, a new SSU is created with a different meaning. In this way the Plot Generator 3 could directly request these new actions.

With reference to FIG. 4H, the Plot Generator 4 maps its narrative actions list into sequences of semantic points called semantic patterns. When a certain action is requested, the characters parameters are fitted and the appropriate shots are extracted. Note that more than one shot can be associated to each semantic point.

Now with reference to FIGS. 5A-5D and by way of example, the Plot Generator 3 requires to the video processing unit 2 the action Borrow Money—Jessica (J)/Antonio (A) that is translated into the following semantic set:
2 shots of Jessica with positive mood, outdoor, night, not crowded
2 shots of Antonio with positive mood, outdoor, night, not crowded
1 shot of Antonio with neutral mood, outdoor, night, not crowded

The video processing unit 2 decides that, by way of example and with reference to FIG. 5A, the scene twelve best fits the mapped action request above because it contains the following clusters:
SC1: Jessica with positive mood, outdoor, night, not crowded—4 shots
SC2: Jessica with negative mood, outdoor, night, not crowded—3 shots
SC3: Antonio with positive mood, outdoor, night, not crowded—3 shots

Now, the video processing unit 2 has to substitute the semantic cluster SC2 (highlighted in the figure), not needed for the required action, with another cluster that contains at least 1 shot of A with neutral mood, outdoor, night, not crowded and that has the smallest visual distance with the clusters SC1 and SC2.

To this end, the video processing unit 2 finds the best candidate in the scene fifteen that, with reference to FIG. 5B is composed by the following clusters:
SC4: Shylock with negative mood, outdoor, night, not crowded
SC5: Antonio with neutral mood, outdoor, night, not crowded
With reference to FIGS. 5D and 5E, the video processing unit 2 respectively replaces SC2 with SC5 in the scene model and then it performs a random walk on the resulting graph to extract the required shots.

Last, the video processing unit 2 validates the scene visual coherence and sends the acknowledgement to the Plot Generator 3.

The present description allows to obtain an innovative system 1 that enables the generation of completely novel filmic variants by recombining original video segments, a full integration between Plot Generator 3 and video processing 2, extends the flexibility of the narrative generation process and decouples the narrative model from the video content.

What is claimed is:

1. A computer implemented method for generating an alternative audible, visual and/or textual data based upon an original audible, visual and/or textual data, comprising the step of:
inputting to a processor of a computer original audible, visual and/or textual data having an original plot;
extracting by means of a computer a plurality of basic segments from said original audible, visual and/or textual data;
defining by means of a computer a vocabulary of intermediate-level semantic concepts based on said plurality of basic segments and/or said original plot;
inputting to said processor of said computer at least an alternative plot based upon said original plot;
modifying by means of a computer said at least an alternative plot in terms of said vocabulary of intermediate-level semantic concepts for generating a modified alternative plot;
modifying by means of a computer the plurality of basic segments of said original audible, visual and/or textual data in terms of said vocabulary of intermediate-level semantic concepts for generating a modified plurality of basic segments;
recombining by means of a computer said modified plurality of basic segments with said modified alternative plot for generating an alternative audible, visual and/or textual data;
reproducing by means of a computer said alternative original audible, visual and/or textual data.

2. A computer implemented method according to claim 1, wherein said plurality of basic segments from said original audible, visual and/or textual data are low-level audible, visual and/or textual content and said plot from said original audible, visual and/or textual data are high-level concepts tied to original audible, visual and/or textual data.

3. A computer implemented method according to claim 1, wherein said intermediate-level semantic concepts comprises raw information on what is actually depicted in the original audible, visual and/or textual data, for identifying a basic unit of semantic information, that embodies the description of one or more plurality of basic segments.

4. A computer implemented method according to claim 1, wherein the step of defining by means of a computer a vocabulary of intermediate-level semantic concepts comprising the further step of:
extracting by means of a computer semantic information from the original audible, visual and/or textual data by:
separating by means of a computer said original audible, visual and/or textual data into basic units of audible, visual and/or textual content and
extracting by means of a computer independently from basic units of audible, visual and/or textual content, either automatically, or manually or both depending on the semantic set forming the vocabulary.

5. A computer implemented method according to claim 4, wherein after the step of selecting by means of a computer at least one concept of said intermediate-level semantic concepts further comprising the step of:
passing by means of a computer the entire semantic information pertaining to original audible, visual and/or textual data, that is all semantic points found in the original audible, visual and/or textual data, along with the number of corresponding for each of said plurality of basic segments.

6. A computer implemented method according to claim 4, wherein at the end of the step of passing by means of a computer the entire semantic information pertaining to original audible, visual and/or textual data, further comprising the step of:
performing by means of a computer a static narrative action filtering to avoid including in the alternative plot actions that are not representable.

7. A computer implemented method according to claim 1, wherein the step of modifying the plurality of basic segments of said original audible, visual and/or textual data in terms of said selected at least one concept for generating a modified plurality of basic segments comprising the further step of:
providing by means of a computer a sequence of semantic patterns that might be considered as new narrative actions as assessed by a human author.

8. A computer implemented method according to claim 1, wherein the step of recombining by means of a computer said modified plurality of basic segments with said alternative plot for generating an alternative audible, visual and/or textual data further comprising the step of:
plot construction by means of a computer which is in a form of a loop, by computing a single narrative action at a time and proceeding to the next action in the plot only after the coherence of the recombined video content correspondent the present action has been evaluated.

9. A computer implemented method according to claims 1 and 2, wherein the step of extracting by means of a computer at least a plot comprises the further step of:
choosing by means of a computer the appropriate narrative actions from a pool of available ones selectable independently from the original audible, visual and/or textual data.

10. A computer implemented method according to claims 1 and 2, wherein the step of extracting by means of a computer a plurality of basic unit segments comprises the further step on top of the basic unit extraction segmenting into logical scenes said original audible, visual and/or textual data.

11. A computer implemented method according to claim 10, wherein the step of segmenting by means of a computer into logical scenes said original audible, visual and/or textual data comprises the further step of:
clustering by means of a computer each logical scene according to their semantic description extracted previously.

12. A computer implemented method according to claim 11, wherein said clusters are associated to nodes of a stochastic Markov chain, in which the transition probabilities are computed using maximum likelihood estimation based on the actual temporal transitions between the plurality of basic unit segments of the original audible, visual and/or textual data.

13. A computer implemented method according to claim 1, wherein said step of recombining said modified plurality of basic segments with said alternative plot for generating an alternative audible, visual and/or textual data alternative further comprises a step of:
choosing by means of a computer an appropriate sequence of said modified plurality of basic segments whose intermediate-level semantic description matches those listed in the requested translated alternative plot.

14. A computer implemented method according to claim 13, wherein the step of choosing comprises the further step of checking if any of said modified plurality of basic segments is a perfect match to the request by controlling if said clusters of a particular scene semantic model have a one-to-one correspondence with each of the requested semantic descriptions and if no such perfect match could be found, further comprising the step of constructing one by modifying a number of semantic models that are the most similar to the request to obtain a mixed semantic model.

15. A computer implemented method according to claim 14, wherein step of constructing one by modifying a number of semantic models that are the most similar to the request to obtain a mixed semantic model further comprising the step of:
substituting by means of a computer appropriate clusters from other semantic models and deleting possible extra unnecessary clusters.

16. A computer implemented method according to claim 15, wherein further comprising the step of selecting by means of a computer the best mixed semantic model by employing a combination of distances computation based on low-level features and high-level heuristics such as the number of clusters that has been needed to substitute and/or delete.

17. A computer implemented method according to claim 16, wherein further comprising the step of extracting by means of a computer said alternative original audible, visual and/or textual data by performing a random walk on the Markov chain associated to the resulting (eventually mixed) semantic model.

18. A computer implemented method according to claim 17, wherein further comprising the step of computing heuristics based on the amount of the variation in the transitions with respect to those of the original model structure for running a visual coherence check.

19. A computer implemented method according to claim 18, wherein the step of computing heuristics is not passed the further step of forcing to change its narrative path.

20. A computer implemented method according to claim 1, wherein the original and alternative audible, visual and/or textual data are a film.

21. A system for generating an audible, visual and/or textual data based upon an original audible, visual and/or textual data, comprising:
processor means for extracting a plurality of basic segments from an original audible, visual and/or textual data;
storing means for a vocabulary of intermediate-level semantic concepts based on said plurality of basic segments and/or said original plot;
means for inputting to said processor at least an alternative plot based upon said original plot;
processor means for modifying said at least an alternative plot in terms of said vocabulary of intermediate-level semantic concepts for generating a modified alternative plot;
processor means for modifying the plurality of basic segments of said original audible, visual and/or textual data in terms of said vocabulary of intermediate-level semantic concepts for generating a modified plurality of basic segments;
processor means for recombining said modified plurality of basic segments with said modified alternative plot for generating an alternative audible, visual and/or textual data;
means for playing said alternative original audible, visual and/or textual data.

22. A system according to claim 21, wherein the processor means for modifying are a video processing unit, the processor means for modifying said at least an alternative plot is a Plot Generator, the processor means for modifying the plurality of basic segments of said original audible, visual and/or textual data in terms of said vocabulary of intermediate-level semantic concepts for generating a modified plurality of basic segments is a semantic integration layer interposed between the video processing unit and a Plot Generator in order to allow that the video processing unit and the Plot Generator exchange data.

23. A system according to claim 22, wherein the video processing unit deals with the low-level content analysis of the input the baseline input movie for extracting a plurality of basic segments from the original film and the Plot Generator takes care of the narrative generation for generating alternative narrative actions with respect to the plot of the baseline input movie.
